(19) United States
(12) Patent Application Publication
(10) Pub. No.: US 2016/0378914 A1
(43) Pub. Date: Dec. 29, 2016

(54) METHOD OF AND APPARATUS FOR IDENTIFYING PHENOTYPE-SPECIFIC GENE NETWORK USING GENE EXPRESSION DATA

(71) Applicant: Samsung Electronics Co., Ltd., Suwon-si (KR)

(72) Inventors: Chihyun Park, Seoul (KR); Sojeong Yun, Hwaseong-si (KR)

(21) Appl. No.: 14/937,345

(22) Filed: Nov. 10, 2015

(30) Foreign Application Priority Data
Jun. 24, 2015 (KR) 10-2015-0090016

(51) Int. Cl. G06F 19/18; G06F 19/12

(52) U.S. Cl. CPC G06F 19/18; G06F 19/12

(57) ABSTRACT

In a method of identifying a phenotype-specific gene network using gene expression data, gene networks are generated using the gene expression data and biological interaction data, a sub-network commonly existing among generated gene networks is searched for, one or more clusters are extracted from a common sub-network, and a cluster related to a change of a phenotype of a biological sample is determined by verifying significance for each of extracted one or more clusters.

### CROSS-REFERENCE TO RELATED APPLICATION

This application claims the benefit of Korean Patent Application No. 10-2015-0090016, filed on Jun. 24, 2015, in the Korean Intellectual Property Office, the disclosure of which is incorporated herein in its entirety by reference.

### BACKGROUND

1. Field

The present disclosure relates to methods and apparatus for identifying a phenotype-specific gene network using gene expression data.

2. Description of the Related Art

A genome signifies all pieces of genetic information included in a living thing. Various technologies of sequencing the genome of a person, such as a DNA chip, next generation sequencing technology, or next generation sequencing technology, have been developed. The analysis of genetic information such as a nucleic acid sequence or a protein is widely used to search for genes that reveal diseases such as diabetes or cancer or to identify a correlation between the genetic diversity and expression characteristics of an individual. In particular, genetic data collected from a person is important in clarifying the genetic characteristics of the person related to the progress of a symptom or disease. Accordingly, genetic data such as the nucleic acid sequence or protein of a person is core data used to identify current and future disease-related information to prevent a disease and choose an optimal treatment method at an initial stage of a disease. Technologies to accurately analyze the genetic data of a person and diagnose a disease thereof using genome detection equipment, such as, a microarray or a DNA chip for detecting single nucleotide polymorphism (SNP) or copy number variation (CNV) as genetic information of a living thing, are under development.

### SUMMARY

Provided are methods and apparatus for identifying a phenotype-specific gene network using gene expression data.

Additional aspects will be set forth in part in the description which follows and, in part, will be apparent from the description, or may be learned by practice of the presented exemplary embodiments.

According to an aspect of an exemplary embodiment, a method of identifying a phenotype-specific gene network using gene expression data includes generating tow or more gene networks corresponding to two or more time points included in the gene expression data using the gene expression data and biological interaction data, searching for a common sub-network commonly existing among the generated gene networks, extracting one or more clusters from the common sub-network, and determining a cluster related to a change of a phenotype of a biological sample by verifying a significance of a development of gene expression levels of gene nodes according to a change of the time points for each of the extracted one or more clusters.

According to an aspect of another exemplary embodiment, there is provided a non-transitory computer readable storage medium having stored thereon a program, which when executed by a computer, performs the above method.

According to an aspect of another exemplary embodiment, an apparatus for identifying a phenotype-specific gene network using gene expression data includes a gene network generator configured to generate gene networks corresponding to time points included in the gene expression data using the gene expression data and biological interaction data, a sub-network detector configured to search for a sub-network commonly existing among the generated gene networks, a cluster extractor configured to extract one or more clusters from the searched sub-network, and a determiner configured to determine a cluster related to a change of a phenotype of a biological sample by verifying a significance of a development of gene expression levels of gene nodes according to a change of the time points for each of extracted clusters.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a view showing a function of a computing apparatus for analyzing gene expression data, according to an exemplary embodiment;

FIG. 2 is a view showing time-series gene expression data, according to an exemplary embodiment;

FIG. 3 is a view showing a phenotype-specific gene network, according to an exemplary embodiment;

FIG. 4A is a block diagram of a hardware configuration of a computing apparatus for analyzing gene expression data, according to an exemplary embodiment;

FIG. 4B is a block diagram of a detailed hardware configuration of a processor of FIG. 4A;

FIG. 5 is a view describing a process of identifying a phenotype-specific gene network by analyzing time-series gene expression data in a computing apparatus, according to an exemplary embodiment;

FIG. 6 is a view describing a process of selecting a gene corresponding to each time point from the time-series gene expression data, according to an exemplary embodiment;

FIG. 7 is a view describing generation of a gene network corresponding to each time point using the gene selected for the time point, according to an exemplary embodiment;

FIG. 8 is a view describing searching a sub-network, according to an exemplary embodiment;

FIG. 9 is a view describing extraction of one or more clusters from a searched sub-network, according to an exemplary embodiment;

FIG. 10 is a view describing verification of whether clusters are related to a phenotypic change, according to an exemplary embodiment;

FIGS. 11A and 11B are views describing verification of whether clusters are related to a phenotypic change, through a random test, according to an exemplary embodiment;

FIG. 12 is a view describing gene ontology analysis of a cluster that is determined to correspond to a phenotype-specific gene network, according to an exemplary embodiment;

FIGS. 13A to 13D are views describing simulation processes of identifying a phenotype-specific gene network from published time-series microarray data GSE41714, according to an exemplary embodiment;

FIGS. 14A to 14E are views describing simulation processes performed by selecting some genes related to a cell cycle included in the published time-series microarray data GSE41714, according to another exemplary embodiment;

FIGS. 15A to 15D are views describing simulation processes of identifying a phenotype-specific gene network from published time-series microarray data GSE15299, according to another exemplary embodiment; and

FIG. 16 is a flowchart of a method of identifying a phenotype-specific gene network using gene expression data, according to an exemplary embodiment.

### DETAILED DESCRIPTION

The terms used in the present disclosure have been selected from currently widely used general terms in consideration of the functions in the present disclosure. However, the terms may vary according to the intention of one of ordinary skill in the art, case precedents, and the advent of new technologies. Also, for special cases, meanings of the terms selected by the applicant are described below in the description section. Accordingly, the terms used in the present disclosure are defined based on their meanings in relation to the contents discussed throughout the specification, not by their simple meanings.

In the present specification, when a constituent element “connects” or is “connected” to another constituent element, the constituent element contacts or is connected to the other constituent element not only directly, but also indirectly through at least one of other constituent elements interposed therebetween. Also, when a part may “include” a certain constituent element, unless specified otherwise, it may not be construed to exclude another constituent element but may be construed to further include other constituent elements. Terms such as “ . . . unit”, “module”, etc. stated in the specification may signify a unit to process at least one function or operation and the unit may be embodied by hardware, software, or a combination of hardware and software.

Terms such as “include” or “comprise” may not be construed to necessarily include any and all constituent elements or steps described in the specification, but may be construed to exclude some of the constituent elements or steps or further include additional constituent elements or steps.

Also, terms such as “first” and “second” are used herein merely to describe a variety of constituent elements, but the constituent elements are not limited by the terms. Such terms are used only for the purpose of distinguishing one constituent element from another constituent element.

The attached drawings for illustrating various embodiments are referred to in order to gain a sufficient understanding of the present embodiments, the merits thereof, and the objectives accomplished by the implementation of the present embodiments. Hereinafter, the present embodiments will be described below with reference to the attached drawings. Like reference numerals in the drawings denote like elements.

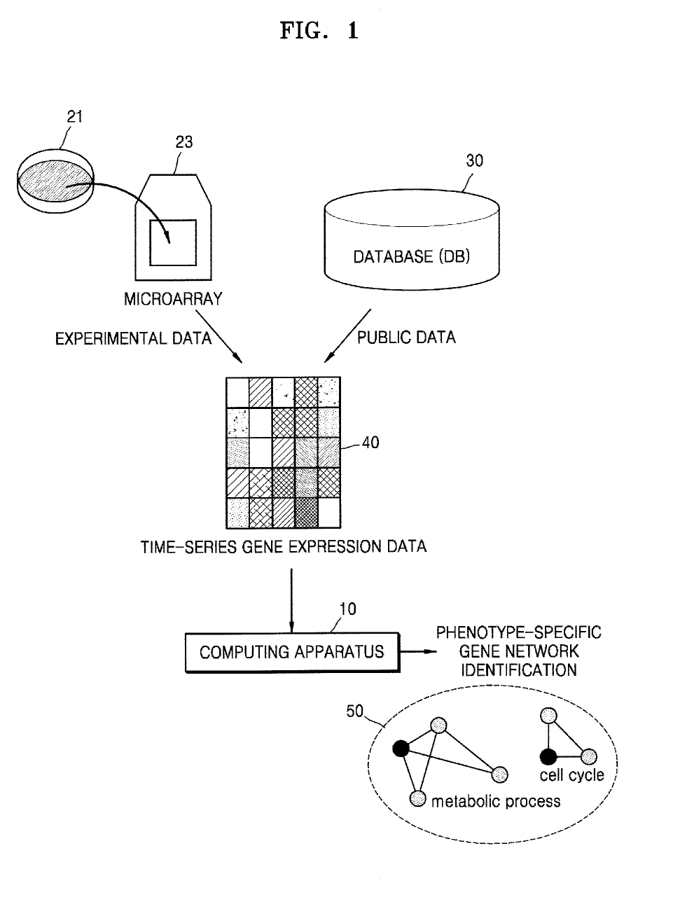

FIG. 1 is a view for describing a function of a computing apparatus 10 for analyzing gene expression data, according to an exemplary embodiment. Referring to FIG. 1, the computing apparatus 10 receives and analyzes time-series gene expression data 40 and identifies a phenotype-specific gene network 50.

The time-series gene expression data 40 may be experimentally obtained. For example, after obtaining a biological sample 21 of a testee, the biological sample 21 is reacted to a microarray 23 for each specific or certain time point, thereby obtaining the time-series gene expression data 40. When contacting the biological sample 21 to be analyzed, the microarray 23 provides a result of mixing a nucleic acid of the biological sample 21 with several hundreds to several hundred thousands of probes on a substrate of the microarray 23. When the biological sample 21 and probes react to each other, different degrees of hybridization are expressed according to a complementary degree of the biological sample 21 and the probe material. A degree of hybridization may generally correspond to intensity of a fluorescence signal. A fluorescence signal may be detected by reacting the biological sample 21 marked with a fluorescence material to the microarray 23, irradiating an excitation light toward the fluorescence material, and detecting an emissive light generated from the fluorescence material. In other words, various high content cell imaging technologies that are well-known in the art may be used as the technology to detect the fluorescence signal of the microarray 23. As intensities of fluorescence signals detected from the microarray 23 for each specific or certain time point are converted to numerical data by various high content cell imaging devices, a tester may obtain the time-series gene expression data 40 with respect to the biological sample 21.

Furthermore, the time-series gene expression data 40 may be stored in a database (DB) 30 such as an open database. For example, the time-series gene expression data 40 may be stored in an open DB 30 such as the National Center for Biotechnology Information (NCBI), or the Gene Expression Omnibus (GEO), which is already well-known in the art. However, since new gene expression data is continuously developed and updated due to development of gene analysis technology, the gene expression data to be described in the present exemplary embodiment is not limited to only data that may be obtained from an open DB 30.

The computing apparatus 10 receives the time-series gene expression data 40 that is experimentally obtained or from the DB 30. Then, the computing apparatus 10 analyzes the received time-series gene expression data 40 and identifies the phenotype-specific gene network 50 from the received time-series gene expression data 40.

The term “phenotype” may signify a phenotype of the biological sample 21 when the received time-series gene expression data 40 is experimental data, or a phenotype of a target sample of the time-series gene expression data 40 obtained from the DB 30 when the received time-series gene expression data 40 is open data. In the present exemplary embodiments, the term “phenotype” may be used in a macroscopic sense such as senescence or cancer, or in a microscopic sense such as a cell cycle or a metabolic process to described senescence or cancer at a molecular level.

Recently, as a functional correlation between genes included in a genome is gradually revealed due to the development of genome research, analysis of a gene network among genes is being highlighted. This is because every physiological phenomenon occurring in a living thing is generated by an interaction of several genes, not by a single gene. The term “gene network” is used to indicate a network that is complicatedly connected among genes, in which genes are represented by nodes and connections between genes are represented by edges. The gene network is a concept that is accessible through numerous theses and patents, which may be understood by one or ordinary skill in the art.

In other words, the computing apparatus 10 may identify, for example, a gene network related to a phenotype “metabolic process” or a gene network related to a phenotype “cell cycle”, from the time-series gene expression data 40.

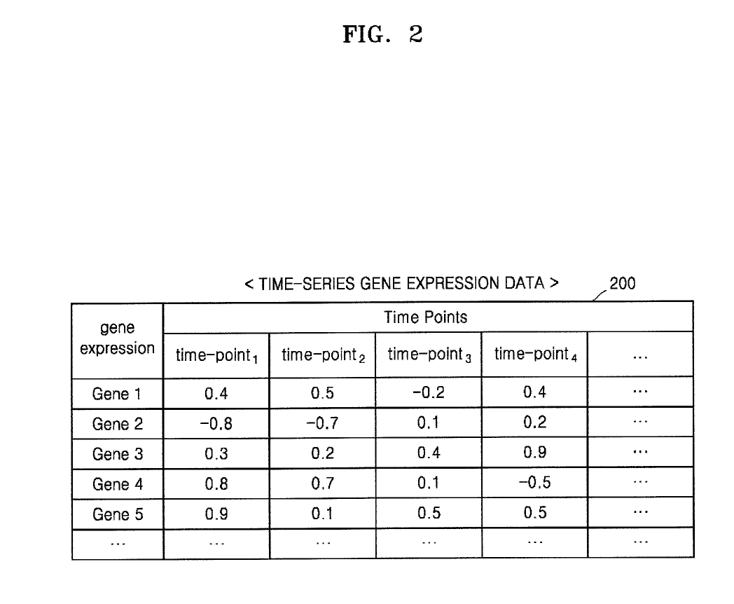

FIG. 2 is a view showing time-series gene expression data 200, according to an exemplary embodiment. Referring to FIG. 2, items included in the time-series gene expression data 200 are arbitrarily given for convenience of explanation.

For example, the time-series gene expression data 200 may be a gene expression profile including gene expression levels of genes Gene 1, Gene 2, Gene 3, Gene 4, Gene 5, etc. at a time point₁, gene expression levels of genes Gene 1, Gene 2, Gene 3, Gene 4, Gene 5, etc. at a time point₂, gene expression levels of genes Gene 1, Gene 2, Gene 3, Gene 4, Gene 5, etc. at a time point₃, gene expression levels of genes Gene 1, Gene 2, Gene 3, Gene 4, Gene 5, etc. at a time point₄, etc. In other words, the time-series gene expression data 200 according to the present exemplary embodiment includes data about a gene expression level of each gene for each specific time point. Values of the gene expression levels illustrated in FIG. 2 are arbitrary, relative values, and the time-series gene expression data 200 may include various gene expression levels corresponding to various genes and various time points.

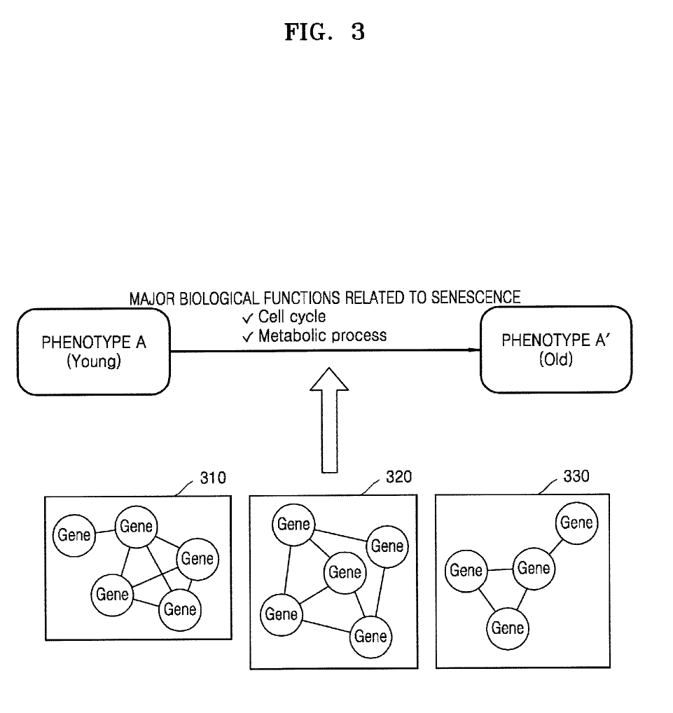

FIG. 3 is a view showing a phenotype-specific gene network, according to an exemplary embodiment. In FIG. 1, the computing apparatus 10 is described as being capable of identifying the phenotype-specific gene network 50.

Referring to FIG. 3, phenotype-specific gene networks 310, 320, and 330 may be networks that are biologically and biophysically related to a change from a phenotype A to a phenotype A′. For example, assuming that the phenotype-specific gene networks 310, 320, and 330 are networks in charge of biological functions that change a phenotype A of a young phase to a phenotype A′ of a old phase, the gene network 310 may correspond to a network related to a cell cycle function in a senescence process and the gene networks 320 and 330 may correspond to a network related to a metabolic process function in the senescence process. In other words, the computing apparatus 10 of FIG. 1 may perform an operation of identifying specific gene networks 310, 320, and 330 related to a phenotype that changes according to the passage of time, using the given time-series gene expression data 40 of FIG. 1.

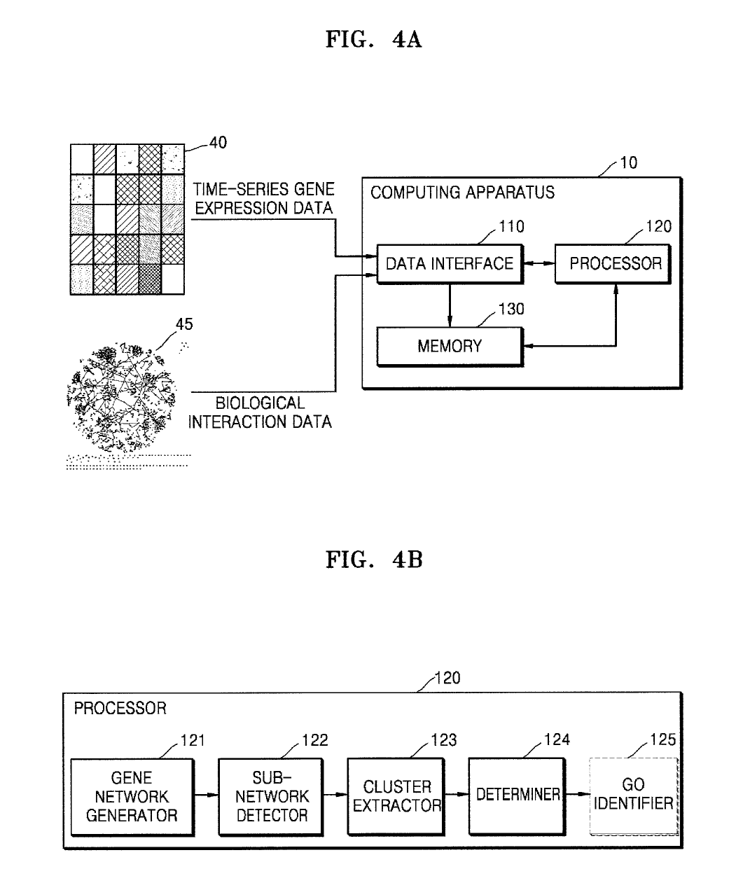

FIG. 4A is a block diagram of a hardware configuration of a computing apparatus that analyzes gene expression data, according to an exemplary embodiment.

Referring to FIG. 4A, the computing apparatus 10 for analyzing gene expression data may include a data interface 110, a processor 120, and a memory 130. For convenience of description, only constituent elements of the computing apparatus 10 related to the present exemplary embodiment are shown in FIG. 4A. Accordingly, the computing apparatus 10 may include other common constituent elements in addition to the constituent elements illustrated in FIG. 4A.

The data interface 110, as described above with reference to FIG. 1, obtains the time-series gene expression data 40 experimentally measured from the biological sample 21 of FIG. 1 or stored in the DB 30 of FIG. 1. The data interface 110 may be implemented by hardware as a wired/wireless network interface so that the computing apparatus 10 may communicate with other external devices.

Furthermore, the data interface 110 obtains biological interaction data 45. The biological interaction data 45 may include interaction data that indicates dynamics, functional correlation, and biophysical relation among various biological materials, for example, protein-protein interaction (PPI) data, gene-gene interaction (GGI) data, and transcriptional-regulatory networks data. The data interface 110 may obtain the biological interaction data 45 from the DB 30 of FIG. 1, which may include an open DB and/or a non-open DB.

The data interface 110 may obtain the time-series gene expression data 40 and the biological interaction data 45 regardless of sources of the time-series gene expression data 40 and the biological interaction data 45.

The memory 130 includes hardware to store data to be processed in the computing apparatus 10 and results that have been processed, and may include memory chips such as random access memory (RAM) or read only memory (ROM), or storage devices such as hard disk drives (HDDs) or solid state drives (SSDs). The memory 130 may store the time-series gene expression data 40 and the biological interaction data 45, which are obtained by the data interface 110, and data about the phenotype-specific gene network 50 of FIG. 1 that is analyzed by the processor 120.

The processor 120 includes hardware for analyzing genes that analyzes the phenotype-specific gene network 50 of FIG. 1 using the time-series gene expression data 40 and the biological interaction data 45. The processor 120 includes a module implemented by one or more processing units, and may be implemented by a combination of a microprocessor having an array of a plurality of logic gates and a memory module storing a program that may be executed in the microprocessor. The processor 120 may be implemented in the form of one or more modules of an applied program.

Identification information of the phenotype-specific gene network 50 of FIG. 1 analyzed by the processor 120 may be transmitted to other external devices, for example a display device or other computing apparatus via the data interface 110, or to an external network, for example, Internet, or the DB 30 of FIG. 1.

FIG. 4B is a block diagram of a detailed hardware configuration of a processor of FIG. 4A.

Referring to FIG. 4B, the processor 120 may include various functional modules such as a gene network generator 121, a sub-network detector 122, a cluster extractor 123, and a determiner 124. The processor 120 may optionally include a gene ontology (GO) identifier 125. For convenience of description, only constituent elements of the processor 120 related to the present exemplary embodiment are shown in FIG. 4B. Accordingly, other common constituent elements may be further provided in addition to the constituent elements illustrated in FIG. 4B. The gene network generator 121, the sub-network detector 122, the cluster extractor 123, the determiner 124, and the GO identifier 125 are classified by separate independent names according to the functions thereof. The gene network generator 121, the sub-network detector 122, the cluster extractor 123, the determiner 124, and the GO identifier 125 may be implemented by a single processor, for example, the processor 120. Alternatively, each of the gene network generator 121, the sub-network detector 122, the cluster extractor 123, the determiner 124, and the GO identifier 125 may correspond to one or more processing modules in the processor 120. Alternatively, the gene network generator 121, the sub-network detector 122, the cluster extractor 123, the determiner 124, and the GO identifier 125 may correspond to separate software algorithm units classified according to the functions thereof. In other words, the implemented form of the gene network generator 121, the sub-network detector 122, the cluster extractor 123, the determiner 124, and the GO identifier 125 in the processor 120 is not limited by any one of the above forms.

The gene network generator 121 generates gene networks corresponding to time points included in the time-series gene expression data 40 by using gene expression data, that is, the time-series gene expression data 40 and the biological interaction data 45. The biological interaction data 45 may be, for example, PPI data.

The gene network generator 121 searches the biological interaction data 45 for interactions among genes included in the time-series gene expression data 40 for each time point. Then, the gene network generator 121 generates a gene network having a structure in which gene nodes corresponding to genes are connected by edges corresponding to searched interactions for each time point.

In order to search for interactions, the gene network generator 121 selects genes having statistically significant gene expression levels at each time point, among the genes included in the time-series gene expression data 40. The gene network generator 121 may select genes corresponding to each time point, based on perturbation scores with respect to gene expression levels included in the time-series gene expression data 40. Then, the gene network generator 121 searches the biological interaction data 45 for interactions among the genes selected for each time point.

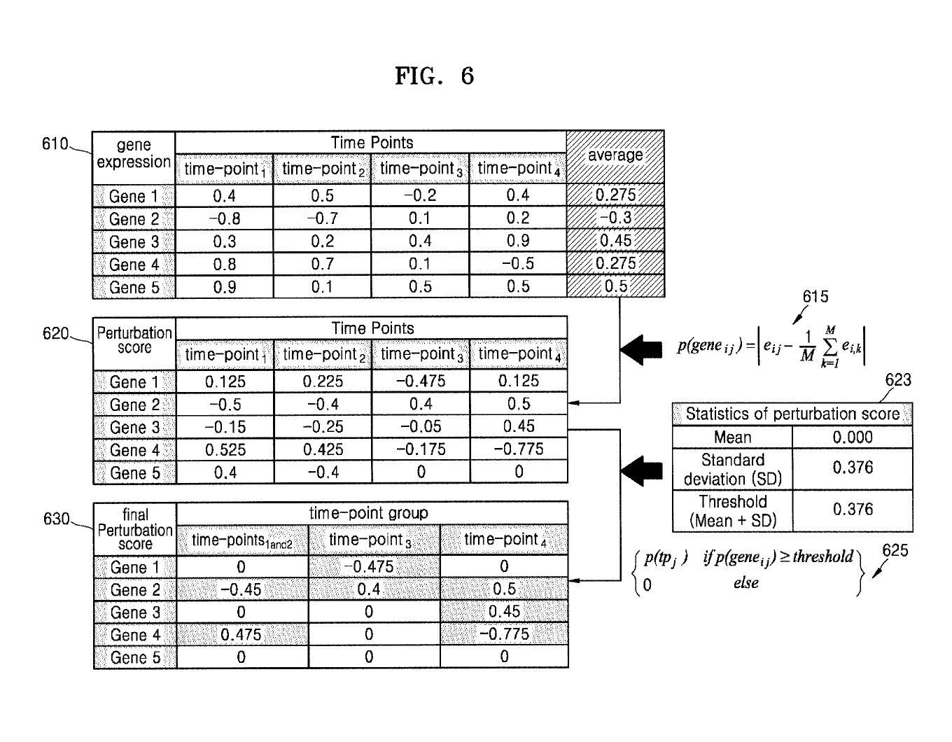

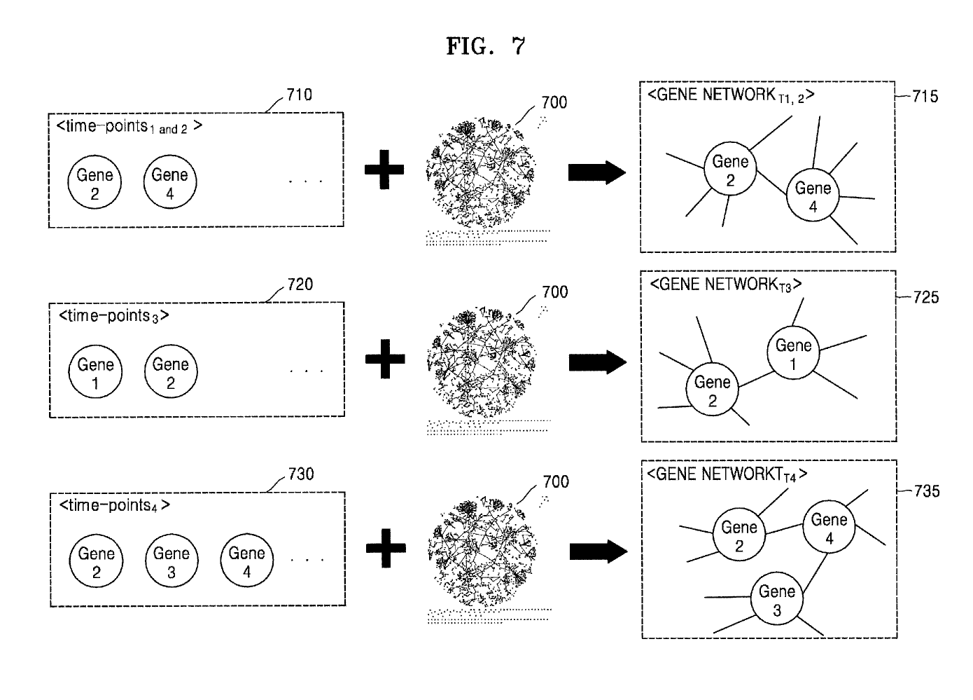

The gene network generator 121 may generate a gene network corresponding to each of the time points. For example, referring to the time-series gene expression data 200 of FIG. 2, the gene network generator 121 may generate a gene network corresponding to the time point₁, a gene network corresponding to the time point₂, a gene network corresponding to the time point₃, and a gene network corresponding to the time point₄. The generation of gene networks corresponding to the time points will be described below with reference to FIGS. 6 and 7. Alternatively, since the gene network generator 121 does not generate a gene network based on a probability algorithm such as a Bayesian network, with respect to the time-series gene expression data 40, a gene network may be generated in an accurate and fast fashion.

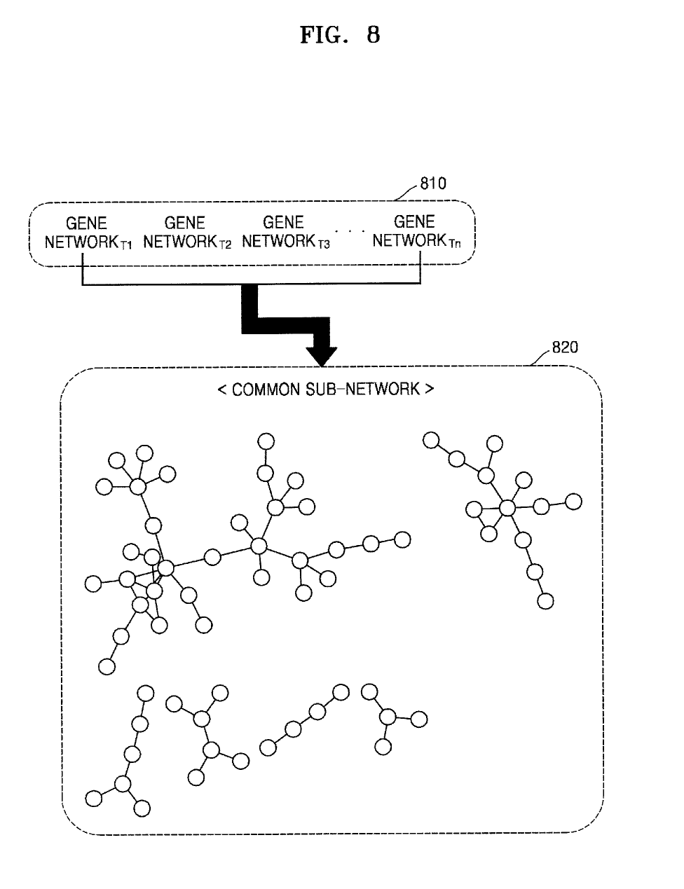

The sub-network detector 122 searches for and determines a common sub-network that exists between generated gene networks. A determined common sub-network is a partial area that is common to each of the gene networks, and has a shape of common gene nodes and edges. However, the present disclosure is not limited thereto and, if all generated gene networks are the same, the sub-network may be the generated gene networks themselves. The search of a sub-network will be described below with reference to FIG. 8.

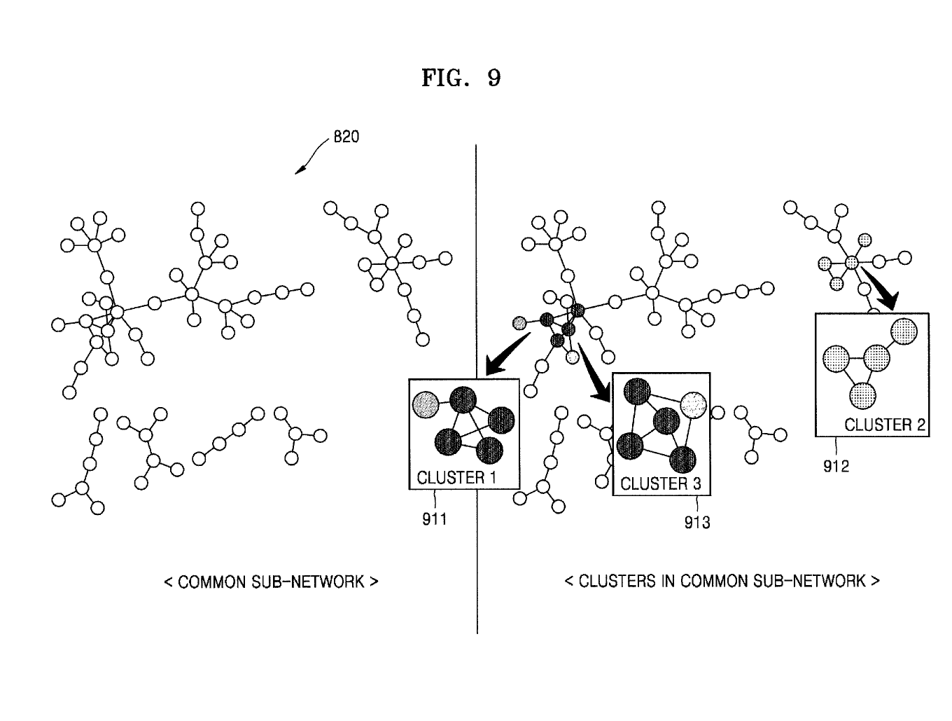

The cluster extractor 123 extracts one or more clusters from the common sub-network. Extracted clusters, in which N or more gene nodes, where N is a natural number, are connected by M or more edges where M is a natural number, are a part of a sub-network. The numbers of N and M may be equal to or different from each other. The extracted clusters signify a small-scale network structure of an area where gene nodes and edges are relatively densely aggregated in a sub-network. The cluster extractor 123 may extract one or more clusters based on clustering algorithm for topological analysis on a common sub-network, for example, a Cluster One algorithm, an MCODE algorithm, or a Markov Cluster algorithm (MCL). For example, when a network structure in which four or more gene nodes are connected by five or more edges exists in a sub-network, the cluster extractor 123 may extract the network structure as a cluster. The extraction of a cluster will be described below with reference to FIG. 9.

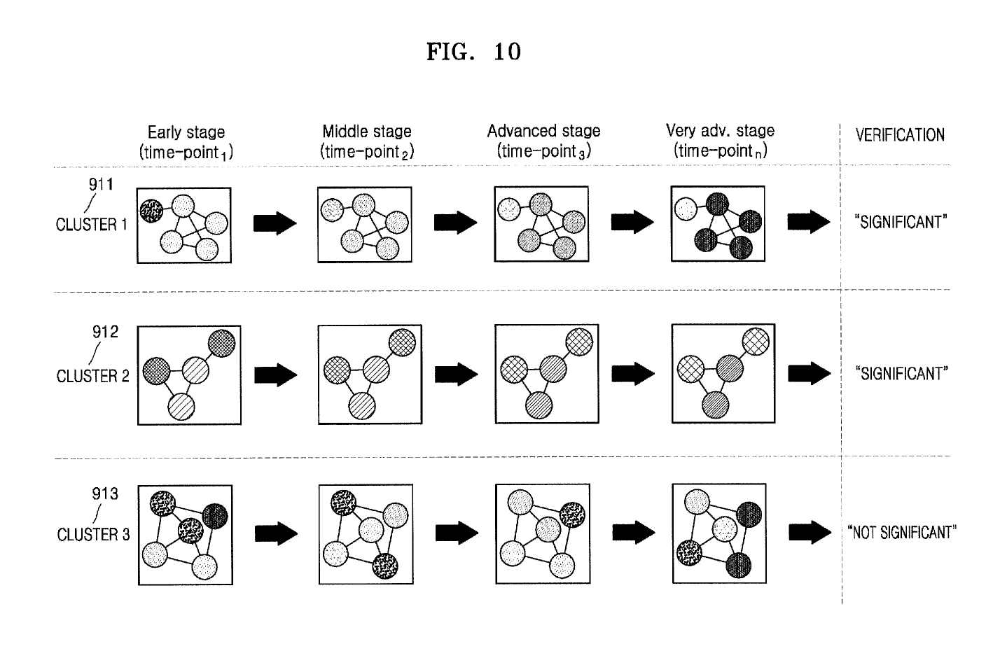

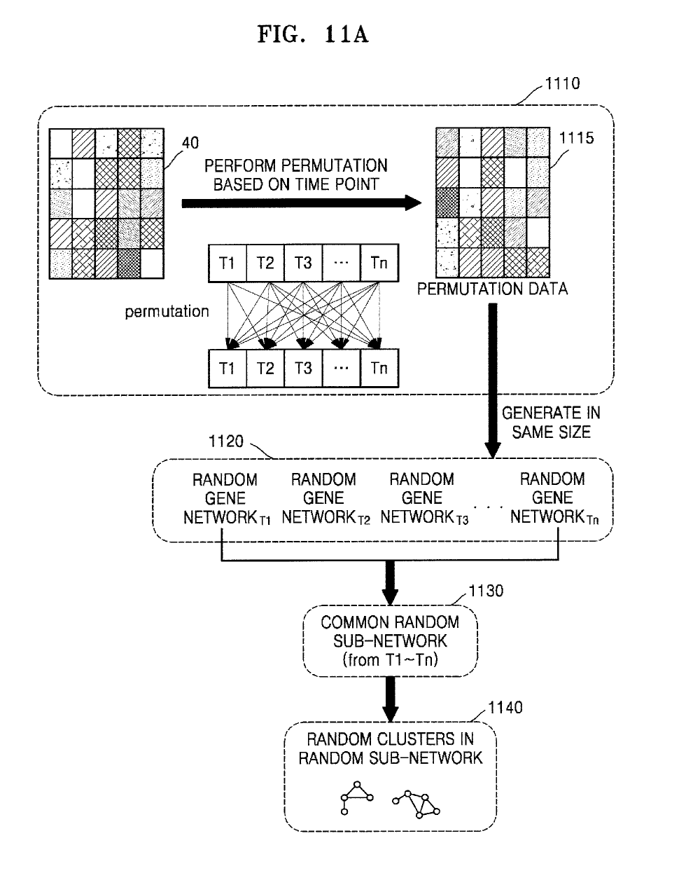

The determiner 124 determines a cluster related to a changed phenotype of a biological sample by verifying significance of development of the gene expression levels of gene nodes according to the change of time points, for each extracted cluster. When the development according to the change of time points is gradual, the determiner 124 may determine the cluster to be significant. The verification of significance will be described below with reference to FIG. 10.

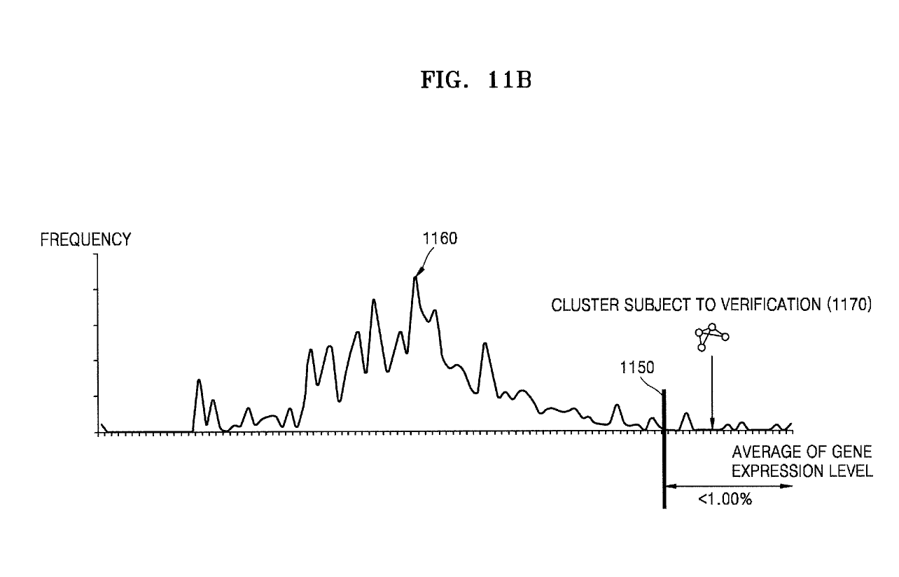

The determiner 124 may determine a significant cluster through a random test using a random cluster extracted from permutation data of the time-series gene expression data 40. The determination of a signification cluster will be described below with reference to FIGS. 11A and 11B.

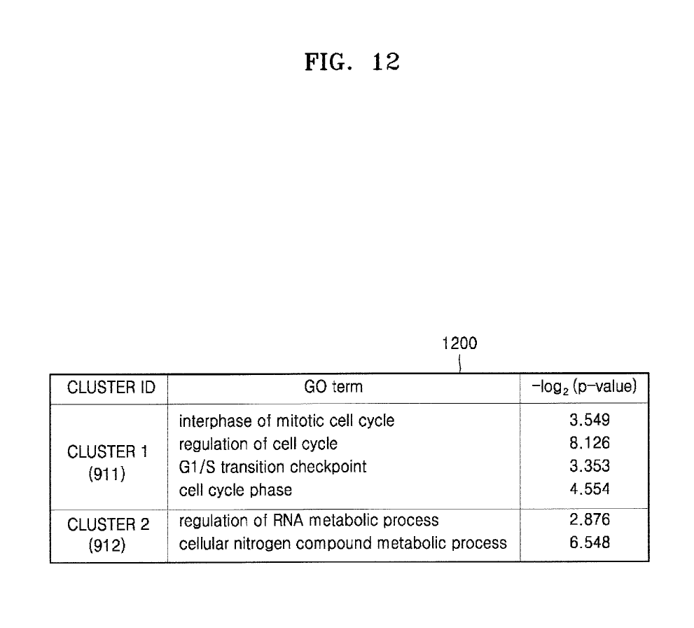

The GO identifier 125 identifies correlations with phenotypes using a gene ontology analysis on a determined cluster. The GO identifier 125 transmits information about the determined cluster to an external gene ontology DB (not shown) via the data interface 110, and receives an analysis result of the gene ontology DB via the data interface 110, thereby identifying phenotype information about the determined cluster. FIGS. 12, 13D, 14D, and 15D illustrate gene ontology information (GO terms) indicating the phenotype of a cluster.

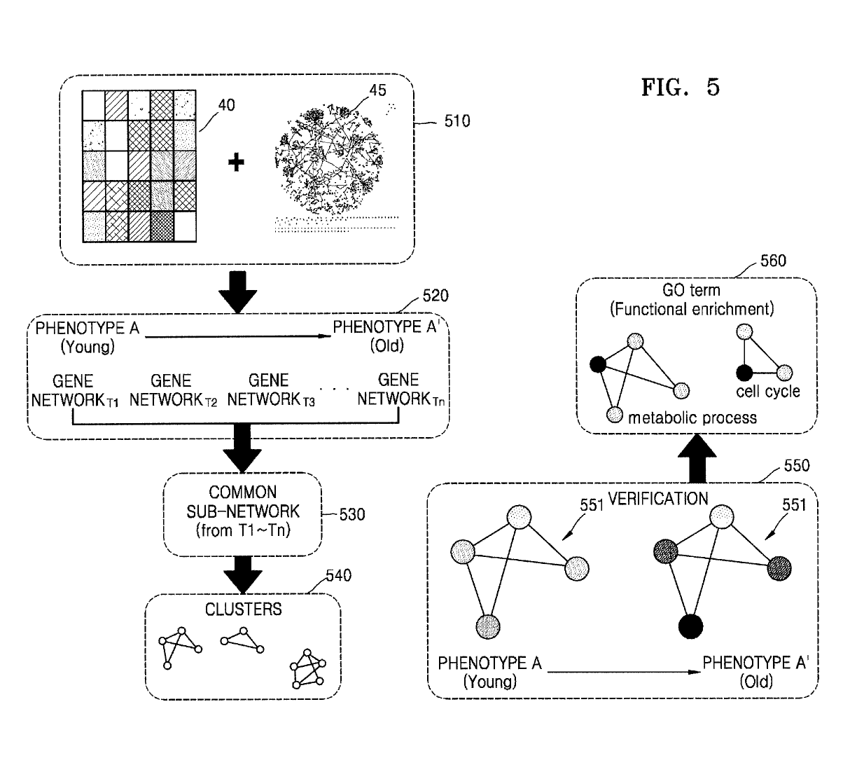

FIG. 5 is a view showing a process of identifying a phenotype-specific gene network by analyzing time-series gene expression data in a computing apparatus, according to an exemplary embodiment.

In an operation 510, first, the gene network generator 121 merges or combines the time-series gene expression data 40 and the biological interaction data 45. In detail, the gene network generator 121 identifies interactions of the genes selected for each time point included the time-series gene expression data 40, from the biological interaction data 45, for example, PPI data.

In an operation 520, the gene network generator 121 establishes a structure of gene nodes and edges based on interactions of genes identified for each time point, and generates gene networks corresponding to the respective time points. For example, the gene network generator 121 generates a gene network_{T1}, a gene network_{T2}, a gene network_{T3}, . . . , a gene network_{Tn}, respectively corresponding to the respective time points between from a time point_{T1} of a young phase expressed by phenotype A to a time point_{Tn} of an old phase expressed by phenotype A′.

In an operation 530, the sub-network detector 122 searches for a sub-network that commonly exists among the gene network_{T1}, the gene network_{T2}, the gene network_{T3}, . . . , the gene network_{Tn}.

In an operation 540, the cluster extractor 123 extracts one or more clusters from a sub-network. In the present exemplary embodiment, although the extracted cluster is described to mainly have a network structure formed of parts of gene nodes and edges of a sub-network, the sub-network may become a cluster. In other words, the operation 540 may be omitted according to another exemplary embodiment.

In an operation 550, the determiner 124 determines a cluster corresponding to a gene network specific to a phenotypic change, for example, a change from a phenotype A (young) to a phenotype A′ (old), by verifying each of the extracted clusters. For example, when a change between a gene expression level 551 of genes of a cluster in a young phase and a gene expression level 552 of genes of a cluster in an old phase gradually increases or decreases, the cluster, as a significant cluster, may be determined to be a gene network specific to a phenotypic change, for example, a change from a phenotype A (young) to a phenotype A′ (old). Alternatively, whether a change of a gene expression level of a cluster according to the passage of time is significant may be determined through a random test of FIGS. 11A and 11B, in addition to the recognizing whether the change is gradual. There may be a variety of verification methods.

An operation 560 is optional. For example, the computing apparatus 10 may complete the operation by determining only a verified cluster specific to a phenotypic change. However, when identification information about a phenotype to which a determined cluster is related is required, the computing apparatus 10 may additionally perform the operation 560.

In the operation 560, the GO identifier 125 identifies correlation with a phenotype with respect to a determined cluster, by performing functional enrichment such as gene ontology analysis on the cluster determined in the operation 550.

FIG. 6 is a view showing a process of selecting a gene corresponding to each time point from the time-series gene expression data, according to an exemplary embodiment. The process described in FIG. 6 may be performed in the operation 510 of FIG. 5.

The original time-series gene expression data is assumed in this example to be the data 200 described above in FIG. 2.

A table 610 includes a column in which averages of gene expression levels of each gene are listed, in addition to the time-series gene expression data 40 of FIG. 1. For example, from the time point₁ to the time point₄, an average of Gene 1 is 0.275, an average of Gene 2 is −0.3, an average of Gene 3 is 0.45, an average of Gene 4 is 0.275, and an average of the Gene 5 is 0.5.

In a table 620, perturbation scores (PSs) of genes for each time point, which are calculated using the averages in the table 610, are listed. A perturbation score (PS) may be calculated using Equation 1 (615):

$$p ( {gene}_{ij} ) = \vert {e}_{ij} - \frac{1}{M} {\sum }_{k = 1}^{M} {e}_{i , k} \vert . \qquad [ Equation 1 ]$$

Referring to Equation 1, “i” denotes a row, that is, a gene, of the table 610 and “j” denotes a column, that is, a time point, of the table 610. In other words, i=1 denotes Gene 1 and j=1 denotes a time point₁. “e” denotes a gene expression level of i-th gene at a time point j. “M” denotes the number of all time points in the time-series gene expression data that is used. “p(geneᵢⱼ)” denotes a perturbation score (PS) of the i-th gene at the time point j.

For example, since a gene expression level of Gene 1 at the time point₁ is 0.4, the perturbation score (PS) of Gene 1 at time point₁ may be calculated to be 0.125 by using Equation 1. In the same manner, the perturbation scores (PSs) of each gene for each time point may be calculated, the perturbation scores (PSs) are shown in the table 620.

A table 630 shows a list of final perturbation scores (PSs) calculated by using the perturbation scores (PSs) in the table 620. In the table 623, means and standard deviations (SDs) that are statistical amounts of the perturbation scores (PSs) included in the table 620 are shown and also threshold values obtained by using the means and standard deviations are shown. In FIG. 6, a threshold value is assumed as a value obtained by adding a mean and a standard deviation, but the present disclosure is not limited thereto.

A final PS may be obtained according to Equation 2 (625):

$$\{ \begin{matrix}p ( {gene}_{ij} ) & if p ( {gene}_{ij} ) \geq threshold \\ 0 & else\end{matrix} \} . \qquad [ Equation 2 ]$$

Referring to Equation 2, “p(geneᵢⱼ)” denotes a perturbation score (PS) of the i-th gene at the time point j. In other words, among the perturbation scores (PSs) in the table 620, a perturbation score (PS) less than the threshold value is calculated such that the final PS is 0. However, among the perturbation scores (PSs), a perturbation score (PS) equal to or greater than the threshold value is calculated such that the perturbation score (PS) is the final PS. For example, the perturbation score (PS) of Gene 1 at the time point₄ is 0.125 that is less than a threshold value of 0.376, the final PS of Gene 1 at the time point₄ is calculated to be 0 by Equation 2. Also, the perturbation score (PS) of Gene 2 at the time point₄ is 0.5 that is greater than the threshold value of 0.376, the final PS of Gene 2 at the time point₄ is calculated to be 0.5 by Equation 2.

Table 630 contains the final PSs calculated by using Equation 2 as described above. However, in some cases, as shown in the table 630, the final PSs of the time point₁ and the final PSs of the time point₂ may be merged or combined with each other. However, unlike the above, the final PSs of the time point₁ and the final PSs of the time point₂ may be classified into separate columns. The present disclosure is not limited to any one of the above-described cases.

The gene network generator 121 calculates the final PSs of each gene for each time point using the above-described tables 610, 620, 623, and 630 and the equations 615 and 625. That the gene network generator 121 calculates a statistical amount like the final PSs is to select meaningful genes for each time point. For example, at the time points_{1 and 2}, except for Genes 1, 3, and 5 having the final PSs of 0, only Genes 2 and 4 having the final PSs that are not 0 may be genes significantly related to the phenotype expression at the time points_{1 and 2}. In other words, the gene network generator 121 selects Genes 2 and 4 for the time points_{1 and 2}, Genes 1 and 2 for the time point₃, and Genes 2, 3, and 4 for the time point₄. Gene 5 is not selected at any time point, which is a gene that is not related to the phenotypic change from the time point₁ to the time point₄.

However, the perturbation score may be calculated by a statistical method different from the method described in FIG. 6, or other statistical amounts may be used in addition to the perturbation score. In other words, the process of selecting a significant gene for each time point is not limited to any one of the above methods.

FIG. 7 is a view showing generation of a gene network corresponding to each time point using the gene selected for the time point, according to an exemplary embodiment. The descriptions with reference to FIG. 6 are used in the description of the process of FIG. 7. The process of FIG. 7 may be performed in the operations 510 and 520 of FIG. 5. However, although only a total of five genes are illustrated in FIG. 6, the present disclosure is not limited thereto. It is assumed in this example that the time-series gene expression data 200 of FIG. 2 includes five or more genes, and the process of FIG. 7 will be described with the assumption.

As described above with reference to FIG. 6, since Gene 2 and Gene 4 are selected at the time points_{1 and 2}, Gene 2 and Gene 4 correspond to gene nodes 710 at time points_{1 and 2}. It is difficult to identify interactions between the gene nodes 710 (Gene 2 and Gene 4) with only the time-series gene expression data 40 of FIG. 1 or 200 of FIG. 2. Accordingly, as described above in operation 510 of FIG. 5, the gene network generator 121 uses PPI data 700, that is, the biological interaction data 45 of FIG. 1. The PPI data 700 defines interactions between proteins. The protein corresponds to an expression product of genes. When a correlation between proteins and each of the gene nodes 710 (Gene 2 and Gene 4) is analyzed, interactions between the gene nodes 710 (Gene 2 and Gene 4) may be analyzed through the interactions of the proteins included in the PPI data 700. Alternatively, the PPI data 700 may be a PPI referred to in a thesis: Marc Vidal et al., “A proteome-scale map of the human Interactome Network”, Cell, 2014, but the present disclose is not limited thereto.

The interactions between the gene nodes 710 (Gene 2 and Gene 4) analyzed through the PPI data 700 now corresponds to edges between the gene nodes 710 (Gene 2 and Gene 4). Accordingly, the gene network generator 121 generates gene network_{T1,2} (715) corresponding to the time points_{1 and 2}, based on the edges analyzed through the gene nodes 710 (Gene 2 and Gene 4) and the PPI data 700. The gene network generator 121 generates the gene network_{T3} (725) corresponding to the time point₃ and the gene network_{T4} (735) corresponding to the time point₄, in the same manner, by using or combining the gene nodes 720 and 730 and the PPI data 700.

FIG. 8 is a view showing a process of searching a sub-network, according to an exemplary embodiment. The process of FIG. 8 may be performed in the operation 530 of FIG. 5.

As described above, the gene network generator 121 generates gene networks 810 corresponding to the time points T1, T2, T3, . . . , Tn.

The sub-network detector 122 searches for a common sub-network 820 existing in the gene networks 810. The sub-network detector 122 may search for the common sub-network 820 by comparing the gene networks 810 to detect common gene nodes and common edges. However, a method of searching the sub-network detector 122 for the common sub-network 820 is not limited to any of the above methods only if the common sub-network 820 may be searched for from the gene networks 810.

FIG. 9 is a view showing a process of extraction of one or more clusters from a common, searched sub-network, according to an exemplary embodiment. The process of FIG. 9 may be performed in the operation 540 of FIG. 5.

The cluster extractor 123 extracts one or more clusters from the searched common sub-network 820. The extracted clusters may exist in an area of the common sub-network 820 where the gene nodes and edges are relatively densely aggregated.

A plurality of gene nodes connected by a plurality of edges in the common sub-network 820 are highly likely to be related to a phenotype change compared to a relatively small number, for example, two, of gene nodes connected by a relatively small number, for example, one, of edges. Since a function of one gene node of a plurality of gene nodes connected by a plurality of edges interacts with functions of other gene nodes, a change in the gene expression level of any one gene node may generally affect the gene expression levels of the other gene nodes. Accordingly, a cluster including a plurality of gene nodes connected by a plurality of edges may be considered to be a candidate gene network that has a close relation to a phenotypic change or becomes a cause of a phenotypic change.

Accordingly, the cluster extractor 123 may extract in the common sub-network 820 a cluster in which N or more gene nodes, where N is a natural number, such as an integer, are connected by M or more edges, where M is a natural number. N and M may be the same number or different numbers. The cluster extractor 123 may extract one of more clusters based on a cluster ring algorithm, for example, a Cluster One algorithm, for topology analysis of a searched sub-network.

Referring to FIG. 9, the cluster extractor 123 may extract, for example, a cluster 1 911, a cluster 2 912, and a cluster 3 913 from the common sub-network 820.

However, according to another exemplary embodiment, as described above, the common sub-network 820 may correspond to a cluster. For example, if the common sub-network 820 searched by the sub-network detector 122 has the same structure as a structure of the cluster 1 911, the common sub-network 820 itself may be considered to be a cluster without having to separately extract a cluster from the common sub-network 820.

FIG. 10 is a view showing a process of verification of whether clusters are related to a phenotypic change, according to an exemplary embodiment. The process of FIG. 9 may be performed in the operation 550 of FIG. 5. The colors of gene nodes included in the clusters 1, 2, and 3, (911, 912, and 913) represent relative degrees of gene expression levels.

The determiner 124 verifies whether each of the cluster 1 911, the cluster 2 912, and the cluster 3 913 is related to a phenotypic change according to the passage of time from the time point₁ to the time point₄.

The cluster 1 911 includes gene nodes (four gene nodes) having gradually increasing gene expression levels and a gene node (one gene node) having gradually decreasing gene expression levels, according to the passage of time from the time point₁ to the time point₄, that is, a change of phenotype. Accordingly, since development of gene expression levels of gene nodes in the cluster 1 911 gradually increases or decreases corresponding to the passage of time, that is, a change of phenotype, the cluster 1 911 may be determined to be a significant cluster.

Likewise, cluster 2 912 includes gene nodes (two gene nodes) having gradually increasing gene expression levels and gene nodes (two gene node) having gradually decreasing gene expression levels, according to the passage of time from the time point₁ to the time point₄, that is, a change of phenotype. Accordingly, since development of gene expression levels of gene nodes in the cluster 2 912 gradually increases or decreases corresponding to the passage of time, that is, a change of phenotype, the cluster 2 912 may be determined to be a significant cluster.

However, since development of gene expression levels of gene nodes in the cluster 3 913 is random according to the passage of time, the cluster 3 913 may be determined to be a non-significant cluster.

Alternatively, as described in FIG. 10, the analysis of a phenotype-specific gene network according to the present exemplary embodiment may be performed on an assumption that the network structure of a cluster is not changed according to the passage of time and only the gene expression levels of genes in the cluster changes. However, the present disclosure is not limited thereto.

A method of verifying significance of clusters in a quantitative manner will be described with reference to FIGS. 11A and 11B. However, the present disclosure is not limited thereto and the significance of clusters may be verified in different methods other than the method of FIGS. 11A and 11B.

FIGS. 11A and 11B are views showing operations of verification of whether clusters are related to a phenotypic change, through a random test, according to an exemplary embodiment. The operation of FIGS. 11A and 11B may be performed in the operation 550 of FIG. 5.

Referring to FIG. 11A, in an operation 1110, the gene network generator 121 generates permutation data 1115 by performing permutation based on the time points included in the time-series gene expression data 40. Referring to the time-series gene expression data 200 of FIG. 2, each time point in the time-series gene expression data 200 corresponds to a column. The permutation data 1115 with respect to the time-series gene expression data 200 may be generated by permuting the gene expression levels (column data) of a certain gene at each time point.

For example, in the time-series gene expression data 200, for Gene 1, a gene expression level at the time point₁ is 0.4, a gene expression level at the time point₂ is 0.5, a gene expression level at the time point₃ is −0.2, and a gene expression level at the time point₄ is 0.4. However, in the permutation data generated from the time-series gene expression data 200, for Gene 1, a gene expression level at the time point₁ may be 0.5, a gene expression level at the time point₂ may be −0.2, a gene expression level at the time point₃ may be 0.4, and a gene expression level at the time point₄ may be 0.4. In other words, the permutation data 1115 may be generated by randomly permuting the gene expression levels at each time point for a certain gene. However, alternate algorithms for permutation may exist. Accordingly, the above-described permutation method is described for convenience of explanation, and the permutation data 1115 according to the present exemplary embodiment may be generated from the time-series gene expression data 200 in various methods.

In an operation 1120, the gene network generator 121 generates random gene networks corresponding to the respective time points from the permutation data 1115. For example, the gene network generator 121 may generate a random gene network_{T1} corresponding to the time point₁, a random gene network_{T2} corresponding to the time point₂, a random gene network_{T3} corresponding to the time point₃, . . . , a random gene network_{Tn} corresponding to the time pointₙ. The gene network generator 121 may generate random gene networks having the same sizes as the gene networks subject to verification, that is, the gene networks in the operation 520 of FIG. 5 or the gene networks 810 of FIG. 8.

In an operation 1130, the sub-network detector 122 searches for a random sub-network that commonly exists in the random gene networks.

In an operation 1140, the cluster extractor 123 extracts one or more random clusters from a random sub-network.

In the terms “random gene networks”, “random sub-network”, and “random clusters” used in the descriptions of FIGS. 11A and 11B, the word “random” is used for the purpose of verification using a random test, which signifies those generated randomly by permutation.

For verification using a random test, the operations 1110 to 1140 may be repeated several times and a plurality of different random clusters may be extracted through the repetition.

Referring to FIG. 11B, a graph 1160 indicates a distribution of averages of a gene expression level at an initial time point, that is, the time point₁, and a gene expression level at a final time point, that is, the time pointₙ, for each of a plurality of random clusters. A bar 1150 indicates a probability of 1.00% in the graph 1160. When an average of gene expression levels exists at the right side of the bar 1150 in the graph 1160, it means that a probability of occurrence of the average of a certain gene expression level is less than 1.00%. If an average of a gene expression level at the initial time point time point₁ and a gene expression level at the final time point time pointₙ of the cluster subject to verification 1170 belongs to a section of being less than 1.00%, the determiner 124 may verify the cluster to be significant and determine it to be a cluster related to a phenotypic change. However, the standard value of 1.00% used to verify a cluster to be significant may be variously changed to 0.50% or 0.75%.

A random test is to verify whether development of gene expression levels of the cluster subject to verification 1170 is searched at a low probability in a distribution showing the development of gene expression levels of a plurality of random clusters extracted from the time-series gene expression data 40. Being searched at a low probability in a randomly generated population may be considered to be meaningful. Accordingly, the determiner 124 may verify significance of the clusters 911, 912, and 913 of FIG. 9 through the above-described random test.

As a result, the determiner 124 may determine the cluster that is verified to be significant, to correspond to the phenotype-specific gene network 50 of FIG. 1.

FIG. 12 is a view showing a process of gene ontology analysis of a cluster that is determined to correspond to a phenotype-specific gene network, according to an exemplary embodiment. The process of FIG. 12 may be performed in the operation 560 of FIG. 5.

The GO identifier 125 identifies correlation between clusters and a phenotype by analyzing information about clusters determined by the determiner 124, using a gene ontology DB (not shown).

Referring to a table 1200, according to the gene ontology analysis of the cluster 1 911, the GO identifier 125 may identify whether the cluster 1 911 is related to a phenotype of an interphase of a mitotic cell cycle, a phenotype of regulation of a cell cycle, a phenotype of a G1/S development checkpoint, and a phenotype of a cell cycle phase. Also, the GO identifier 125 may identify a degree of involvement in each phenotype by a probability.

Through the above-described methods, the computing apparatus 10 may determine the phenotype-specific gene network 50 from the time-series gene expression data 40 and identify a phenotype to which the determined phenotype-specific gene network 50 is related.

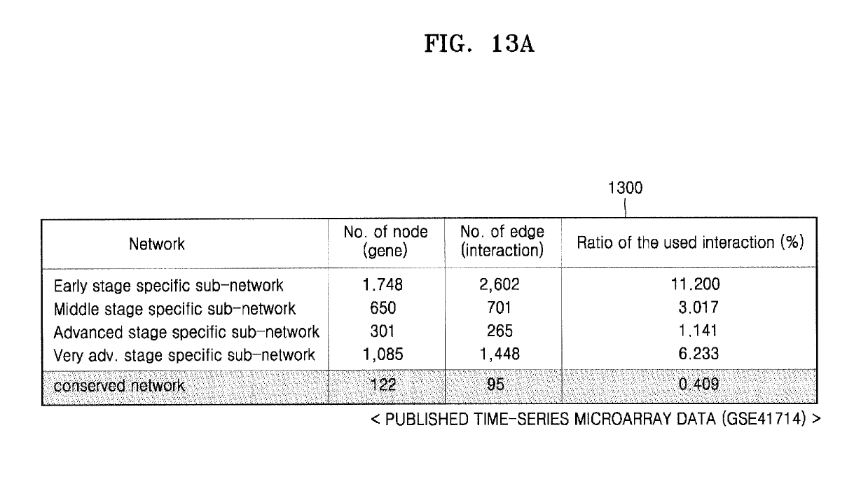

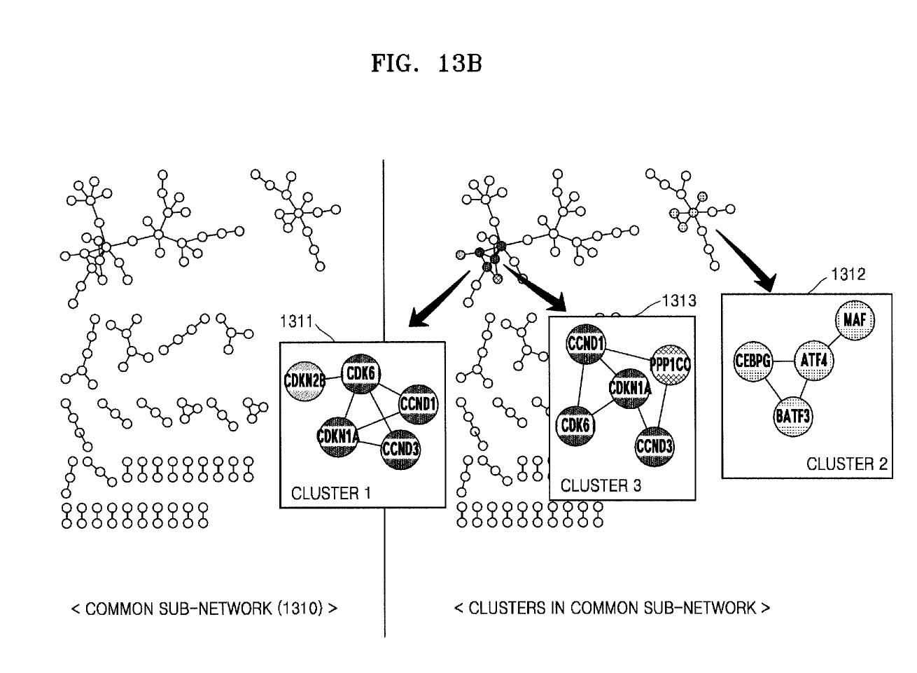

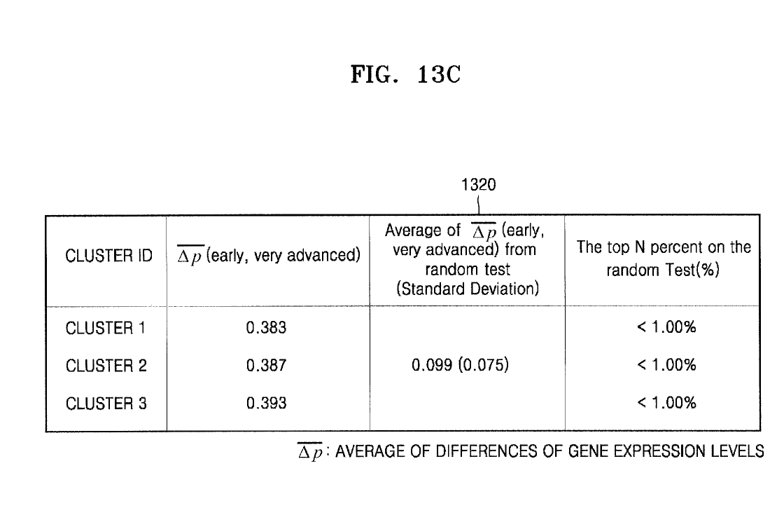

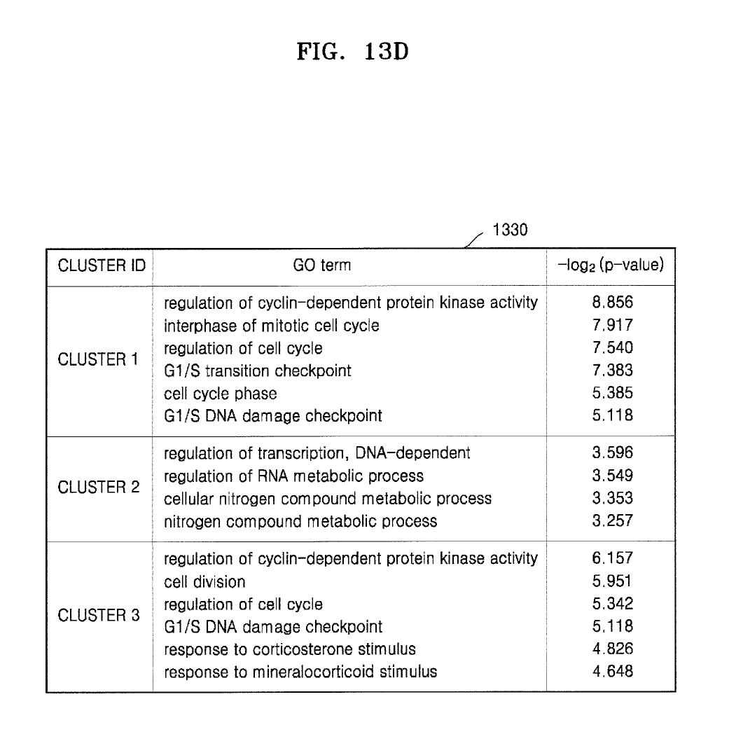

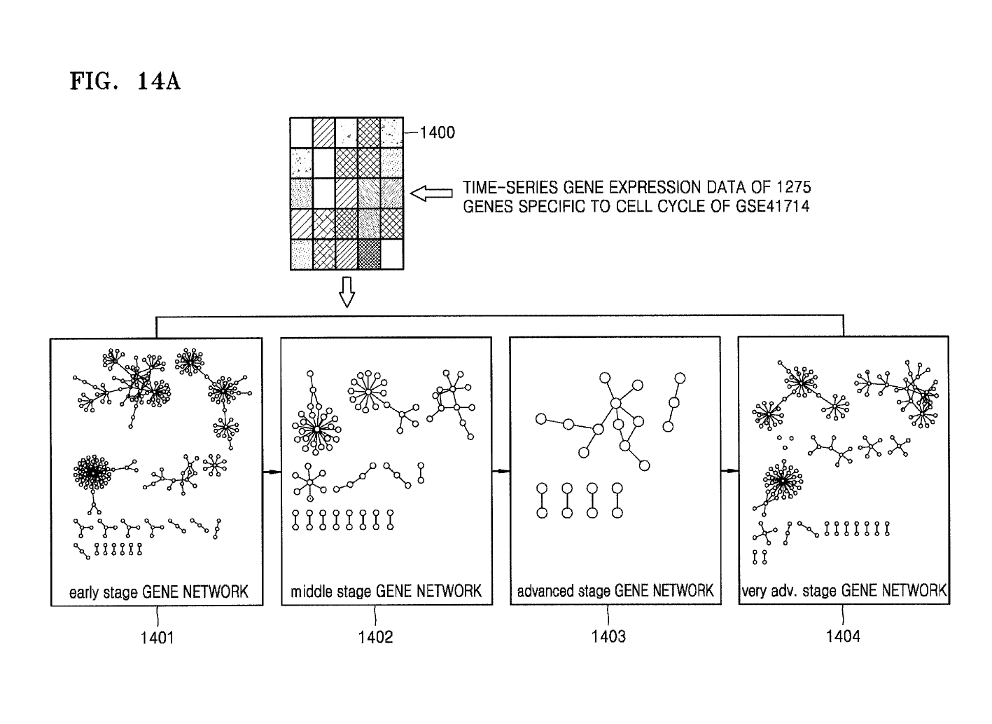

FIGS. 13A to 13D are views for describing simulation processes of identifying a phenotype-specific gene network from published time-series microarray data GSE41714, according to an exemplary embodiment.

Gene Expression Omnibus (GEO) Series (GSE) 41714 that is published time-series microarray data about replicative senescence may be obtained from GEO database (http://www.ncbi.nlm.nih.gov/geo). GSE41714 includes time-series gene expression data about a total of 31,334 genes.

Referring to FIG. 13A, the gene network generator 121 may generate gene networks with respect to each of four time points, that is, an early stage, a middle stage, an advanced stage, and a very advanced stage, through the method described about with reference to FIGS. 6 and 7. The gene network generator 121 calculates the final PS with a threshold value of 0.2.

Referring to a table 1300, a gene network of a early stage has 1,748 gene nodes and 2,602 edges, a gene network of a middle stage has 650 gene nodes and 701 edges, a gene network of a advanced stage has 301 gene nodes and 265 edges, and a gene network of a very advanced stage has 1,085 gene nodes and 95 edges.

Referring to FIG. 13B, the sub-network detector 122 searches for a sub-network 1310 that commonly exists among the gene networks of the early stage, the middle stage, the advanced stage, and the very advanced stage.

The cluster extractor 123 extracts a cluster 1 1311, a cluster 2 1312, and a cluster 3 1313 the sub-network 1310. The respective gene nodes in the clusters 1311, 1312, and 1313 are genes included in GSE41714. In other words, according to the present exemplary embodiment, the clusters 1311, 1312, and 1313 specific to senescence may be extracted from a total of 31,334 genes included in GSE41714.

Referring to FIG. 13C, a table 1320 shows a result of verification of the extracted clusters 1311, 1312, and 1313. The table 1320 may show a result of verification of the clusters 1311, 1312, and 1313 obtained through the random test described. As a result of the random test on the clusters 1311, 1312, and 1313, since all clusters 1311, 1312, and 1313 belong to a section of being less than 1.00%, the determiner 124 verifies that all of the cluster 1 1311, the cluster 2 1312, and the cluster 3 1313 are significant. Accordingly, the determiner 124 determines that the cluster 1 1311, the cluster 2 1312, and the cluster 3 1313 are related to a change of phenotype.

Referring to FIG. 13D, a table 1330 shows a result of gene ontology analysis with respect to the cluster 1 1311, the cluster 2 1312, and the cluster 3 1313. In other words, as shown in the table 1330, the GO identifier 125 may identify detailed phenotypes, that is, GO terms, related to senescence with respect to each of the cluster 1 1311, the cluster 2 1312, and the cluster 3 1313, and degrees (e.g., probabilities) of involvement of clusters in the phenotypes.

According to the simulation result described with reference to FIGS. 13A to 13D, by applying the present exemplary embodiments to the published time-series gene expression data GSE41714 on senescence, gene networks closely related to various phenotypes related to senescence, for example, regulation of cyclin-dependent protein kinase activity, interphase of mitotic cell cycle, regulation of cell cycle, G1/S development checkpoint, cell cycle phase, G1/S DNA damage checkpoint, regulation of transcription, DNA-dependent, and regulation of RNA metabolic process, may be identified.

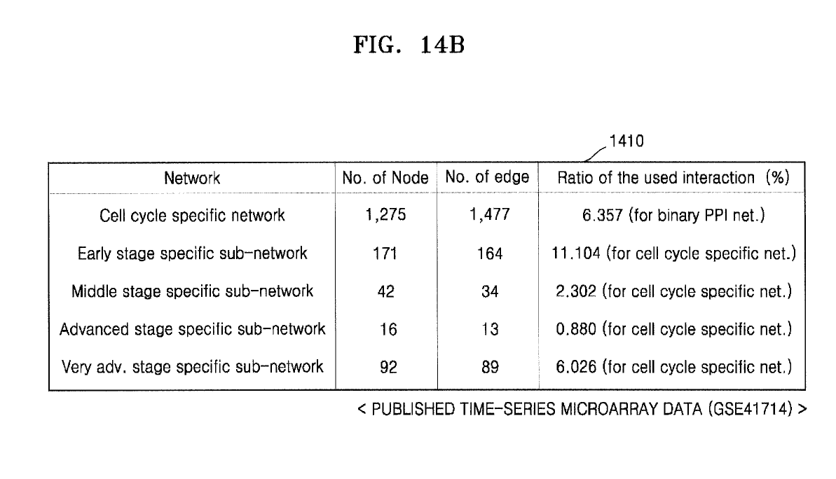

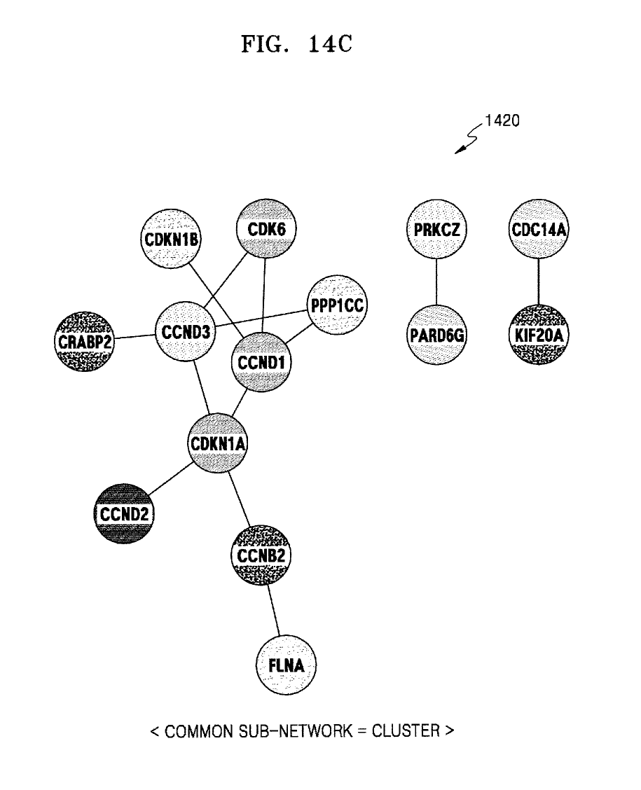

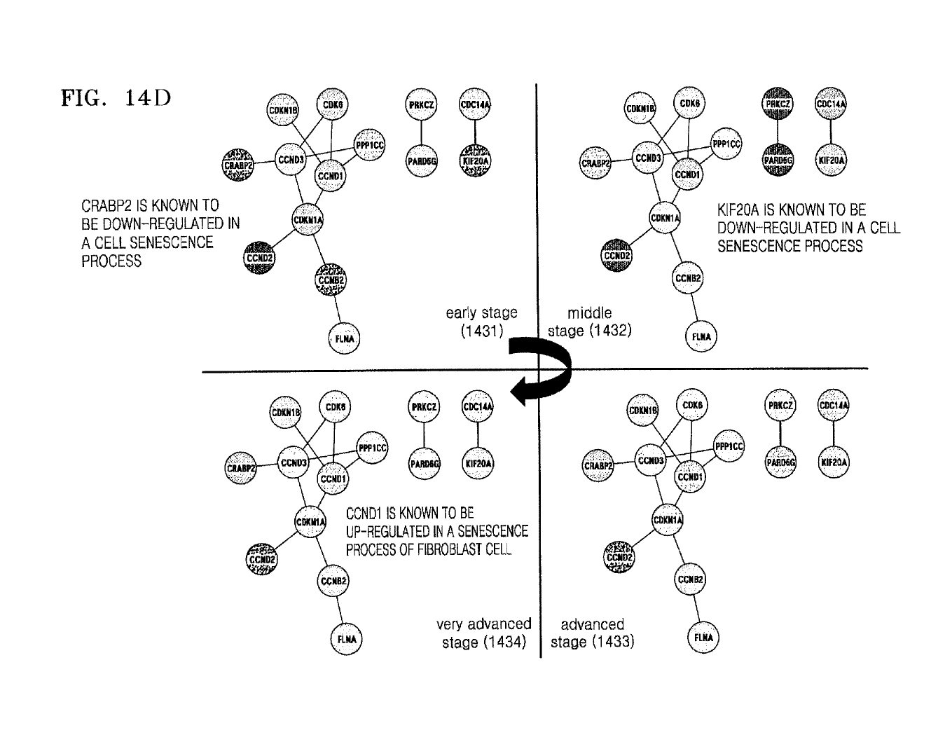

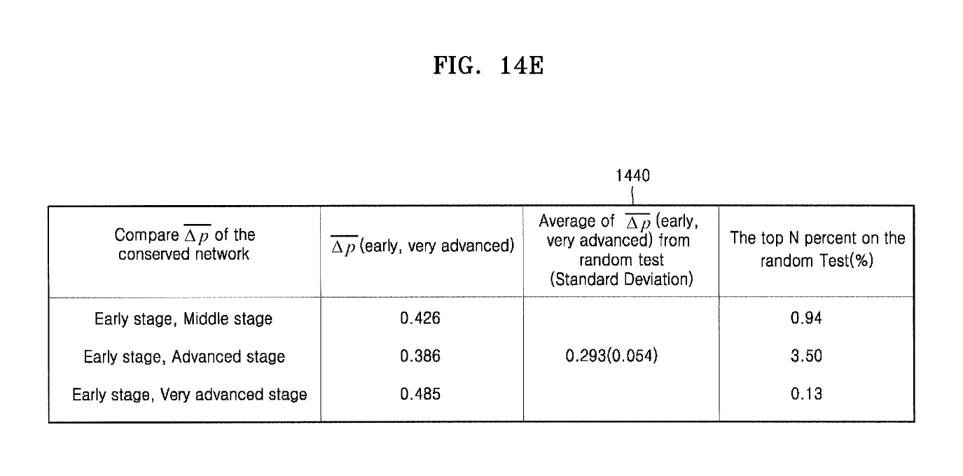

FIGS. 14A to 14E are views showing simulation processes performed by selecting some genes related to a cell cycle included in the published time-series microarray data GSE41714, according to another exemplary embodiment.

Referring to FIG. 14A, not the time-series gene expression data of a total of 31,334 genes included in GSE41714, but time-series gene expression data 1400 of some genes, that is, 1,275 genes specific to a cell cycle, of the total genes included in GSE41714, are used for a simulation.

The gene network generator 121 may generate gene networks 1401, 1402, 1403, and 1404 of the respective four time points, that is, the early stage, the middle stage, the advanced stage, and the very advanced stage, through the method described above with reference to FIGS. 6 and 7.

Referring to a table 1410 of FIG. 14B, 1,477 edges analyzed from the PPI data 700 of FIG. 7 with respect to 1,275 gene nodes and 1,275 gene nodes, specific to a cell cycle, included in the time-series gene expression data 1400, form a base of gene networks.

The gene network generator 121 generates the gene network 1401 of an early stage having 171 gene nodes and 164 edges, the gene network 1402 of a middle stage having 42 gene nodes and 34 edges, the gene network 1403 of an advanced stage having 16 gene nodes and 13 edges, and the gene network 1404 of a very advanced stage having 92 gene nodes and 89 edges, through the above-described methods.

Referring to FIG. 14C, the sub-network detector 122 detects a sub-network 1420 that commonly exits among the gene networks 1401, 1402, 1403, and 1404 of the early stage, the middle stage, the advanced stage, and the very advanced stage. Alternatively, according to the simulation described with reference to FIGS. 14A to 14E, the cluster extractor 123 extracts the sub-network 1420 as one corresponding to a cluster, instead of extracting a partial network of the sub-network 1420. In other words, when the size of the sub-network 1420 is relatively small, the cluster extractor 123 may extracts the sub-network 1420 as a cluster, instead of extracting a separate cluster corresponding to a partial network of the sub-network 1420.

Referring to FIGS. 14D and 14E, the determiner 124 verifies whether development of gene expression levels of the sub-network 1420, that is, a cluster, which changes as time passes from an early stage 1431 to a middle stage 1432, an advanced stage 1433, and a very advanced stage 1434, is significant.

A table 1440 may show a result of verification obtained through the random test described in FIGS. 11A and 11B with respect to the clusters 1311, 1312, and 1313. Referring to the table 1440, all of an average of gene expression levels of the sub-network 1420 (cluster) at the early stage 1431 and the middle stage 1432, an average of gene expression levels of the sub-network 1420 (cluster) at the early stage 1431 and the advanced stage 1433, and an average of gene expression levels of the sub-network 1420 (cluster) at the early stage 1431 and the very advanced stage 1434 being to a section of being less than 1.00%, the determiner 124 verifies that the sub-network 1420 (cluster) is significant. Accordingly, the determiner 124 may verify that the sub-network 1420 (cluster) extracted from 1,275 partial genes specific to a cell cycle of senescence is a cluster related to a change of a phenotype cell cycle related to senescence, as expected.

Alternatively, cellular retinoic acid-binding protein 2 (CRABP2) and kinesin family member 20A (KIF20A) are known to be down-regulated in a cell senescence process, and cyclin-D1 (CCND1) is known to be up-regulated in a senescence process of a fibroblast cell. Since the sub-network 1420 (cluster) including gene nodes of CRABP2, KIF20A, and CCND1, which are known to be related to a change of various phenotypes related to senescence, is verified to be a significant cluster, through the simulation described in FIGS. 14A to 14E according to the present exemplary embodiments, a phenotype-specific gene network may be relatively accurately identified according to the present exemplary embodiments.

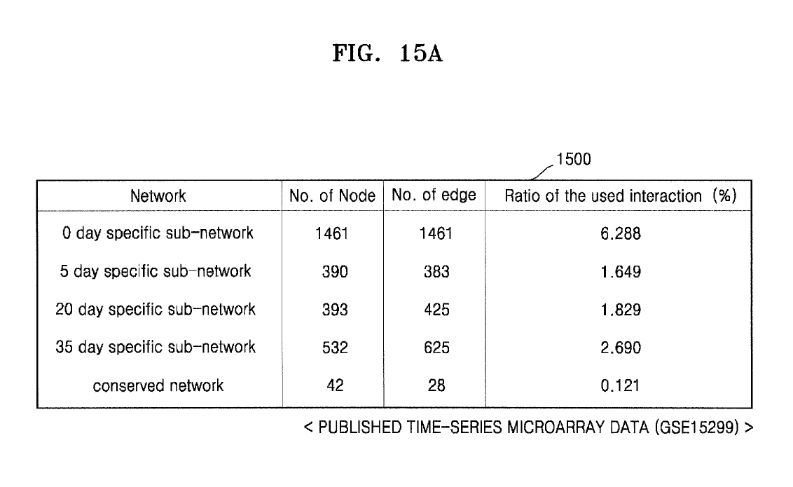

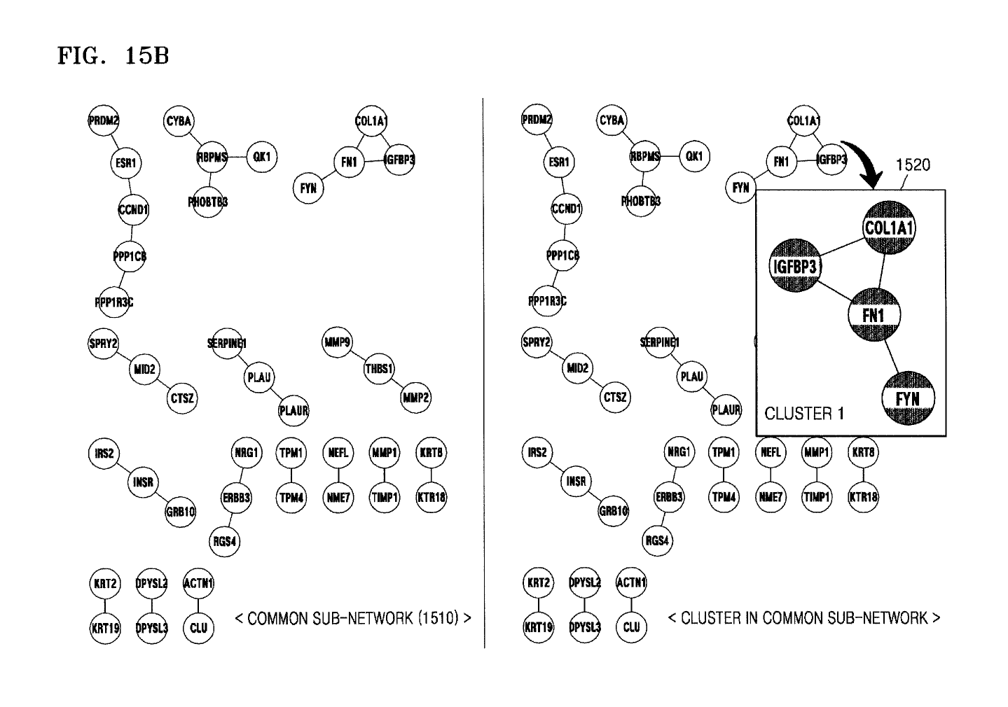

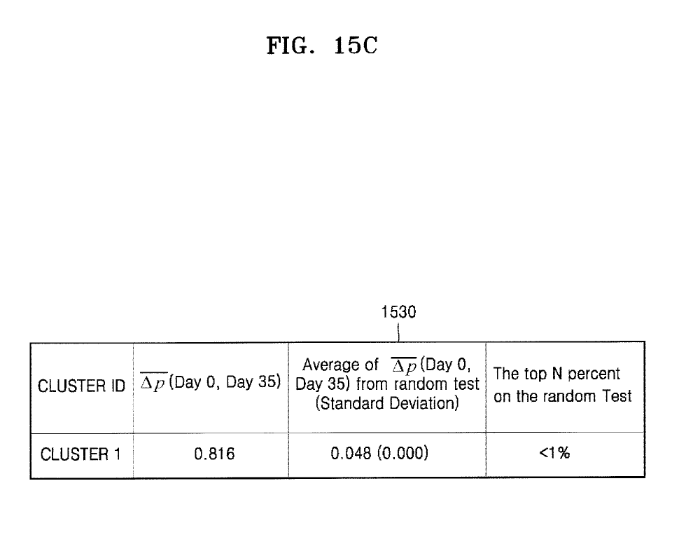

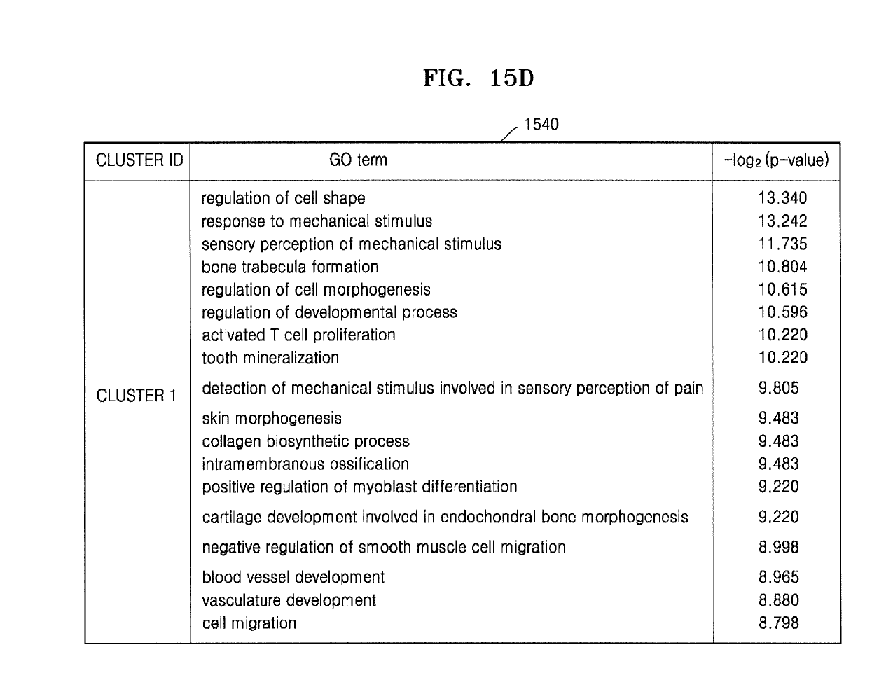

FIGS. 15A to 15D are views showing simulation processes of identifying a phenotype-specific gene network from published time-series microarray data GSE15299, according to another exemplary embodiment.

GSE15299 that is published time-series microarray data regarding cancer progression may be used in the present exemplary embodiment.

Referring to FIG. 15A, the gene network generator 121 may generate gene networks with respect to four time points, that is, 0 day, 5 days, 20 days, and 35 days, through the method described above with reference to FIGS. 6 and 7. In this regard, the gene network generator 121 may calculate the final PS with a threshold value of 2.32.

Referring to a table 1500, a gene network of 0 day may be generated to have 1,461 gene nodes and 1,461 edges, a gene network of 5 days may be generated to have 390 gene nodes and 383 edges, a gene network of 20 days may be generated to have 393 gene nodes and 425 edges, a gene network of 35 days may be generated to have 532 gene nodes and 625 edges.

Referring to FIG. 15B, the sub-network detector 122 searches for a sub-network 1510 that commonly exists among the gene networks of 0 day, 5 days, 20 days, and 35 days. As shown in the table 1500, the sub-network 1510 has 42 gene nodes and 28 edges.

The cluster extractor 123 extracts a cluster 1 1520 from the sub-network 1510. The gene nodes in the cluster 1 1520 are genes included in GSE15299. In other words, according to the present exemplary embodiment, the cluster 1 1520 specific to cancer progression may be extracted from GSE15299.

Referring to FIG. 15C, a table 1530 shows a result of verification of the extracted cluster 1 1520. The table 1530 may show a result of verification of the cluster 1 1520 obtained through the random test described in FIGS. 11A and 11B. Since the cluster 1 1520 belongs to a section of being less than 1.00% as a result of the random test on the cluster 1 1520, the determiner 124 verifies that the cluster 1 1520 is significant. Accordingly, the determiner 124 determines that the cluster 1 1520 is a cluster related to a change of a phenotype related to cancer progression.

Referring to FIG. 15D, a table 1540 shows a result of gene ontology analysis on the cluster 1 1520. In other words, as shown in the table 1540, the GO identifier 125 may identify detailed phenotypes, that is, GO terms, related to cancer progression with respect to the cluster 1 1520, and degrees (e.g., probabilities) of involvement of clusters in the phenotypes.

According to a simulation result described in FIGS. 15A to 15D, by applying the present exemplary embodiments to the published time-series gene expression data GSE15299 related to cancer progression, a gene network that is closely related to various phenotypes related to cancer progression, for example, regulation of cell shape, response to mechanical stimulus, sensory perception of mechanical stimulus, bone trabecula formation, regulation of cell morphogenesis, regulation of developmental process, and activated T cell proliferation, may be identified.

It may be checked from the simulation described in FIGS. 15A to 15D according to the present exemplary embodiments that a gene expression level of insulin-like growth factor-binding protein 3 (IGFBP3) which is known as a tumor suppressor, is high at an initial stage and then gradually decreases according to cancer progression. Also, it may be checked that gene expression levels of fibronectin 1 (FN1), proto-oncogene tyrosine-protein kinase (FYN), and collagen, type I, alpha 1 (COL1A1), which are known as tumor progression parameters, gradually increase according to cancer progression.

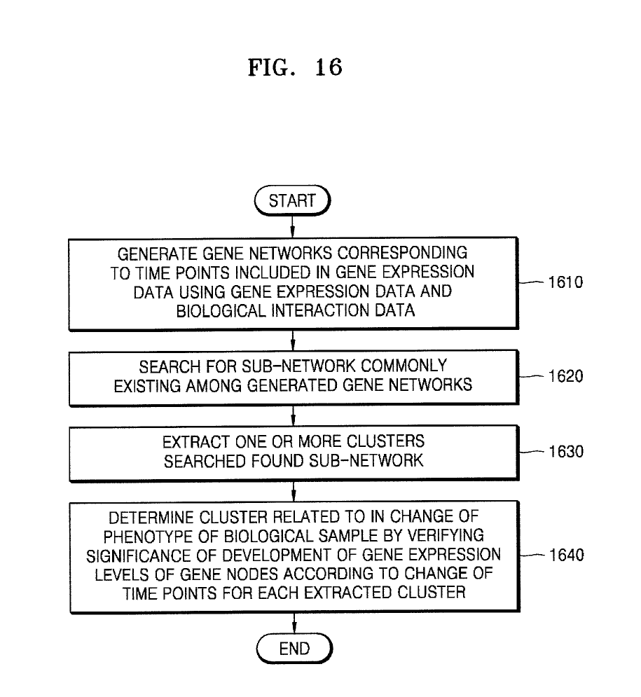

FIG. 16 is a flowchart showing a method of identifying a phenotype-specific gene network using gene expression data, according to an exemplary embodiment. Referring to FIG. 16, a method of identifying a phenotype-specific gene network includes operations that are processed in a time-serial manner in the computing apparatus 10 described with reference to the above-described drawings. Accordingly, the description presented above, through omitted herein, may be applied to the method of identifying a phenotype-specific gene network of FIG. 16.

In an operation 1610, the gene network generator 121 generates gene networks corresponding to time points included in the time-series gene expression data 40, using the time-series gene expression data 40 and the biological interaction data 45.

In an operation 1620, the sub-network detector 122 searches for a sub-network that commonly exists between generated gene networks.

In an operation 1630, the cluster extractor 123 extracts one or more clusters from a searched sub-network.

In an operation 1640, the determiner 124 determines a cluster related to a change of a phenotype of a biological sample, by verifying significance of development of gene expression levels of gene nodes according to a change of the time point, for each extracted cluster.

As described above, a phenotype-specific gene network may be relatively accurately identified from the time-series gene expression data.

The embodiments of the present inventive concept can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described in the figures, it will be understood by those of ordinary skill in the art that various changes in form and details may be made therein without departing from the spirit and scope as defined by the following claims.

What is claimed is:

1. A processor-implemented method of identifying a phenotype-specific gene network using gene expression data, the method comprising the steps, implemented in a processor, of:
receiving gene expression data and biological interaction data;
generating two or more gene networks corresponding to two or more time points included in the gene expression data using the gene expression data and the biological interaction data;
searching for a common sub-network commonly existing among the two or more generated gene networks;
extracting one or more clusters from the common sub-network; and
determining a cluster related to a change of a phenotype of a biological sample by verifying a significance of a development of gene expression levels of gene nodes according to a change of the time points for each of the extracted one or more clusters.

2. The method of claim 1, wherein the one or more extracted clusters, in which N or more gene nodes, where N is a natural number, are connected by M or more edges, where M is a natural number, are parts of the sub-network.

3. The method of claim 2, wherein the extracting of the one or more clusters comprises extracting the one or more clusters based on a topological analysis with respect to the searched sub-network.

4. The method of claim 1, wherein the gene expression data comprises time-series gene expression data in which gene expression levels of genes included in the biological sample are identified for each time point.

5. The method of claim 1, wherein the biological interaction data comprises protein-protein interaction (PPI) data.

6. The method of claim 1, wherein the generating of the two or more gene networks comprises:
searching for interactions between genes included in the gene expression data from the biological interaction data, for each of the two or more time points; and
generating a gene network having a structure in which gene nodes corresponding to the genes are connected by edges corresponding to the searched interactions, for each of the two or more time points.

7. The method of claim 6, wherein the searching of the interactions comprises:
selecting genes having statistically significant gene expression levels at each of the two or more time points among the genes included in the gene expression data; and
searching for the interactions between the selected genes from the biological interaction data, for each of the two or more time points.

8. The method of claim 7, wherein the selecting of the genes comprises selecting the genes corresponding to each of the two or more time points based on a perturbation score with respect to gene expression levels included in the gene expression data.

9. The method of claim 1, wherein the determining of the cluster comprises determining the cluster as a significant cluster when the development according to a change of the time points is gradual.

10. The method of claim 1, wherein the determining of the cluster comprises:
generating permutation data from the gene expression data;
extracting one or more random clusters from a random sub-network generated from the permutation data; and
verifying the significance by statistically comparing the development corresponding to each of the extracted clusters with a development of gene expression levels of gene nodes included in the one or more random clusters.

11. The method of claim 1, further comprising identifying a correlation with the phenotype using gene ontology (GO) analysis with respect to the determined cluster.

12. A non-transitory computer readable storage medium having stored thereon a program, including instructions, which when executed by a computer, cause the computer to perform a method of identifying a phenotype-specific gene network using gene expression data, the program including instructions to:
receive gene expression data and biological interaction data;
generate two or more gene networks corresponding to two or more time points included in the gene expression data using the gene expression data and the biological interaction data;
search for a common sub-network commonly existing among the two or more generated gene networks;
extract one or more clusters from the common sub-network; and
determine a cluster related to a change of a phenotype of a biological sample by verifying a significance of a development of gene expression levels of gene nodes according to a change of the time points for each of the extracted one or more clusters.

13. An apparatus for identifying a phenotype-specific gene network using gene expression data, the apparatus comprising:
a gene network generator configured to generate two or more gene networks corresponding to two or more time points included in the gene expression data using the gene expression data and biological interaction data;
a sub-network detector configured to search for a common sub-network commonly existing among the two or more gene networks;
a cluster extractor configured to extract one or more clusters from the common sub-network; and
a determiner configured to determine a cluster related to a change of a phenotype of a biological sample by verifying a significance of a development of gene expression levels of gene nodes according to a change of the time points for each of the one or more extracted clusters.

14. The apparatus of claim 13, wherein the extracted clusters, in which N or more gene nodes, where N is a natural number, are connected by M or more edges, where M is a natural number, are parts of the sub-network.

15. The apparatus of claim 13, wherein the gene expression data comprises time-series gene expression data in which gene expression levels of genes included in the biological sample are listed for each of the two or more time points.

16. The apparatus of claim 13, wherein the biological interaction data comprises protein-protein interaction (PPI) data.

17. The apparatus of claim 13, wherein the gene network generator searches for interactions between genes included in the gene expression data from the biological interaction data, for each of the two or more time points, and generates a gene network having a structure in which gene nodes corresponding to the genes are connected by edges corresponding to the searched interactions, for each of the two or more time points.

18. The apparatus of claim 17, wherein the gene network generator selects genes having statistically significant gene expression levels at each of the two or more time points among the genes included in the gene expression data, and searches for the interactions between the selected genes from the biological interaction data, for each of the two or more time points.

19. The apparatus of claim 13, wherein the determiner generates permutation data from the gene expression data, extracts one or more random clusters from a random sub-network generated from the permutation data, and verifies the significance by statistically comparing the development corresponding to each of the extracted one or more clusters with a development of gene expression levels of gene nodes included in the random clusters.

20. The apparatus of claim 13, further comprising a gene ontology (GO) identifier that identifies a correlation with the phenotype using a gene ontology analysis with respect to the determined cluster.
